(19) United States
(12) Patent Application Publication
(10) Pub. No.: US 2007/0120644 A1
(43) Pub. Date: May 31, 2007

(54) Smart entry system and warning method thereof

(75) Inventor: Yasushi Seike, Kobe (JP)

Correspondence Address: OLIFF & BERRIDGE, PLC, P.O. BOX 19928, ALEXANDRIA, VA, 22320, US

(73) Assignee: FUJITSU TEN LIMITED, KOBE-SHI (JP)

(21) Appl. No.: 11/599,408

(22) Filed: Nov. 15, 2006

(30) Foreign Application Priority Data
Nov. 25, 2005 (JP) 2005-339798

(51) Int. Cl. G05B 19/00

(52) U.S. Cl. 340/5.61; 340/5.72; 340/426.36

(57) ABSTRACT

A smart entry system for vehicle includes a processing portion that performs a given procedure according to a positional relationship of multiple portable devices with respect to a vehicle, the multiple portable devices being respectively carried by users and being detectable at least whether the multiple portable devices are located inside or outside the vehicle.

### BACKGROUND OF THE INVENTION

1. Field of the Invention

This invention generally relates to a smart entry system in which a vehicle door is locked or unlocked by wireless communication.

2. Description of the Related Art

With smart entry systems, doors of a vehicle are automatically locked or unlocked when a passenger (including a driver) comes close to or moves away from the vehicle with a portable device known as a smart card or smart key. Various smart entry systems have been proposed, as disclosed in Japanese Patent Application Publication No. 2000-16203, Japanese Patent Application Publication No. 2004-189150, Japanese Patent Application Publication No. 2001-349110, and Japanese Patent Application Publication No. 2002-37027.

In the conventional smart entry systems, there is provided at least a function of detecting whether the portable device is located inside or outside the vehicle. With the use of the function, for example, a warning of outputting buzzer or the like is given, when the passenger gets out of the vehicle with the portable device thereof left inside the vehicle and the doors are locked, that is, the lock button at the door handle is pushed, or when the passenger with the portable device gets out of the vehicle with the engine activated. In this manner, the safety or convenience of the vehicle can be enhanced by use of the smart entry systems.

In a smart entry system, each of multiple vehicle passengers is able to carry a portable device. Therefore, if the doors are locked with any of the portable devices left inside the vehicle, a warning is given. In the conventional smart entry systems, however, a warning is not given if, for example, a child freely opens a door while the child is in the vehicle with his/her parent.

### SUMMARY OF THE INVENTION

The present invention has been made in view of the above circumstances and provides a smart entry system and a warning method that can enhance safety and convenience of a vehicle, when multiple vehicle passengers respectively carry portable devices.

According to one aspect of the present invention, there is provided a smart entry system for vehicle including a processing portion that performs a given procedure according to a positional relationship of multiple portable devices with respect to a vehicle, the multiple portable devices being respectively carried by users and being detectable at least whether the multiple portable devices are located inside or outside the vehicle. From the positional relationship of the multiple portable devices with respect to the vehicle, it is possible to assume the state occurring in and around the vehicle. The safety or convenience of the vehicle can be enhanced by performing various processes according to the state.

According to another aspect of the present invention, there is provided a warning method in a smart entry system for vehicle comprising performing a given procedure according to a positional relationship of multiple portable devices with respect to a vehicle, the multiple portable devices being respectively carried by users and being detectable at least whether the multiple portable devices are located inside or outside the vehicle.

### BRIEF DESCRIPTION OF THE DRAWINGS

Preferred exemplary embodiments of the present invention will be described in detail with reference to the following drawings, wherein:

FIG. 1 is a functional block diagram showing a smart entry system in accordance with an exemplary embodiment of the present invention;

FIG. 2 illustrates a configuration example of a portable device;

FIG. 3 illustrates an example in which the smart entry system is applied to a vehicle;

FIG. 4 illustrates a position detection principle of the portable device;

FIG. 5 is a flowchart showing an example of a procedure to give a warning that a child has moved to outside the vehicle freely;

FIG. 6 is a flowchart showing an example of a procedure when a passenger has gotten out of the vehicle and has come back to the vehicle;

FIG. 7 is a flowchart showing an example of a procedure when the passenger has gotten out of the vehicle with the child left inside the vehicle;

FIG. 8 is a flowchart showing an example of a procedure when the vehicle is parked and the passenger gets out of the vehicle;

FIG. 9 is a flowchart showing an example of a procedure when a function of the portable device is customized;

FIG. 10 is a flowchart showing an example of a procedure when the portable device has been dropped inside the vehicle; and

FIG. 11 is a flowchart showing an example of a procedure of a warning process when doors are opened and closed.

### DESCRIPTION OF THE PREFERRED EMBODIMENTS

A description will now be given, with reference to the accompanying drawings, of exemplary embodiments of the present invention.

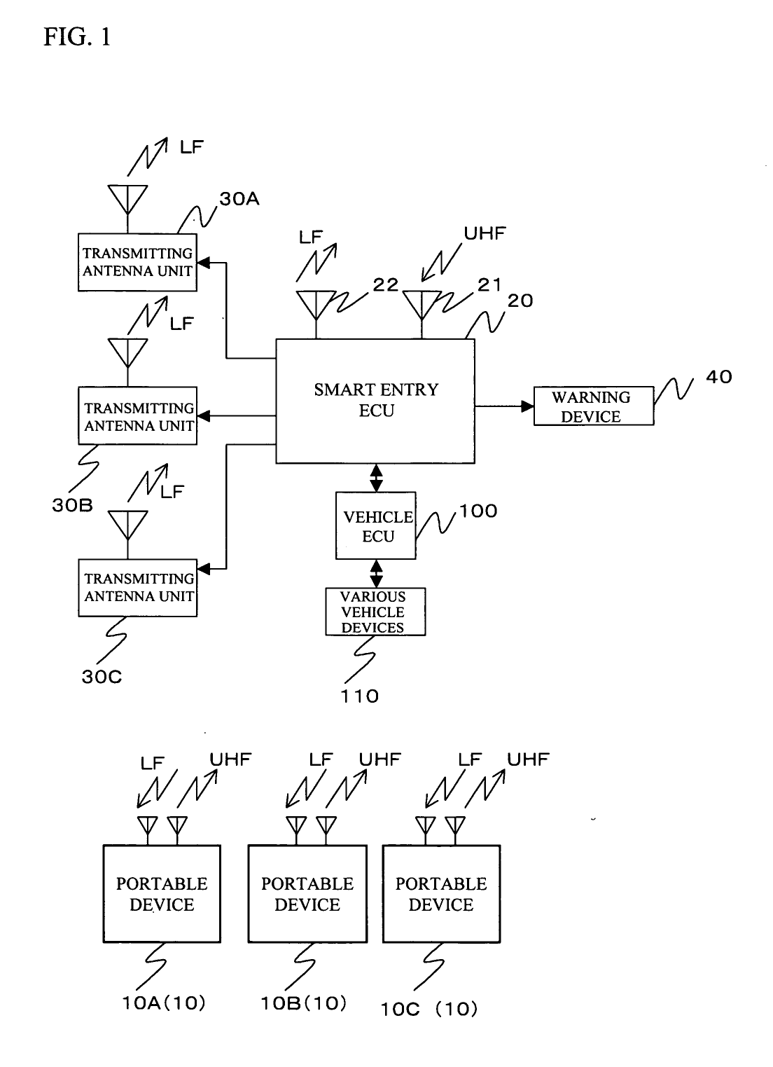

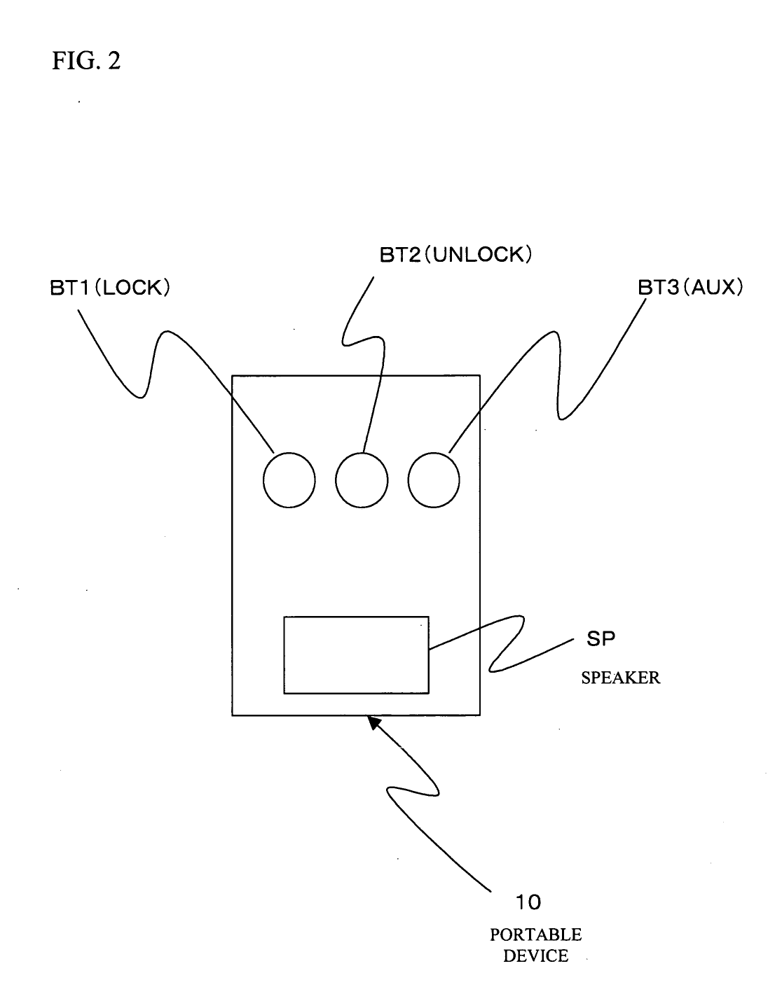

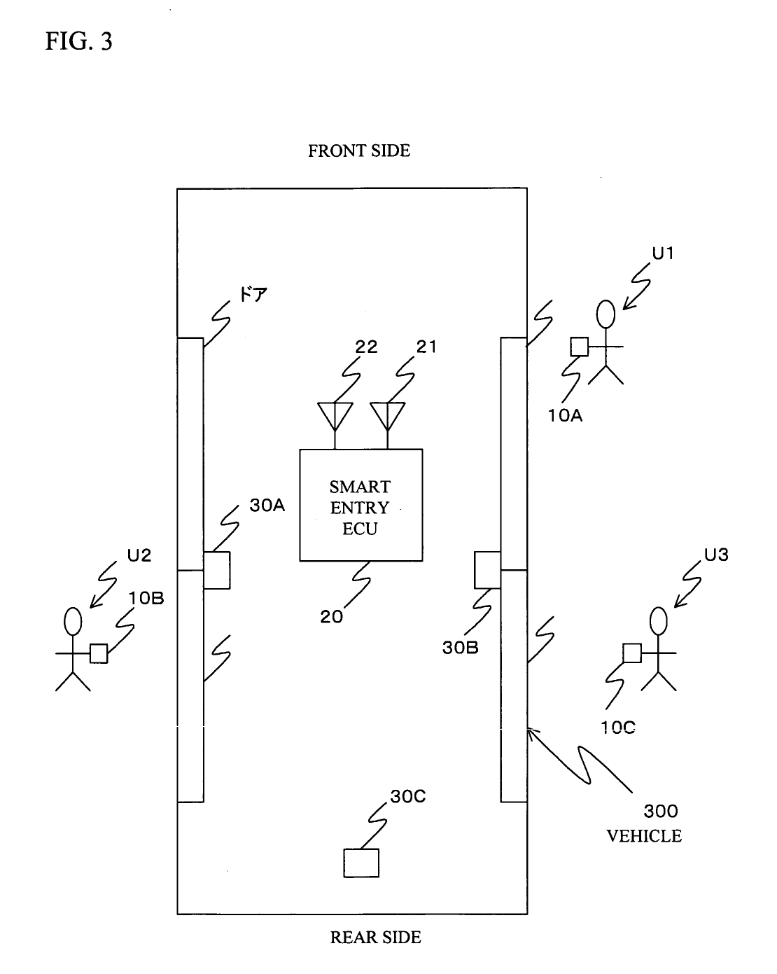

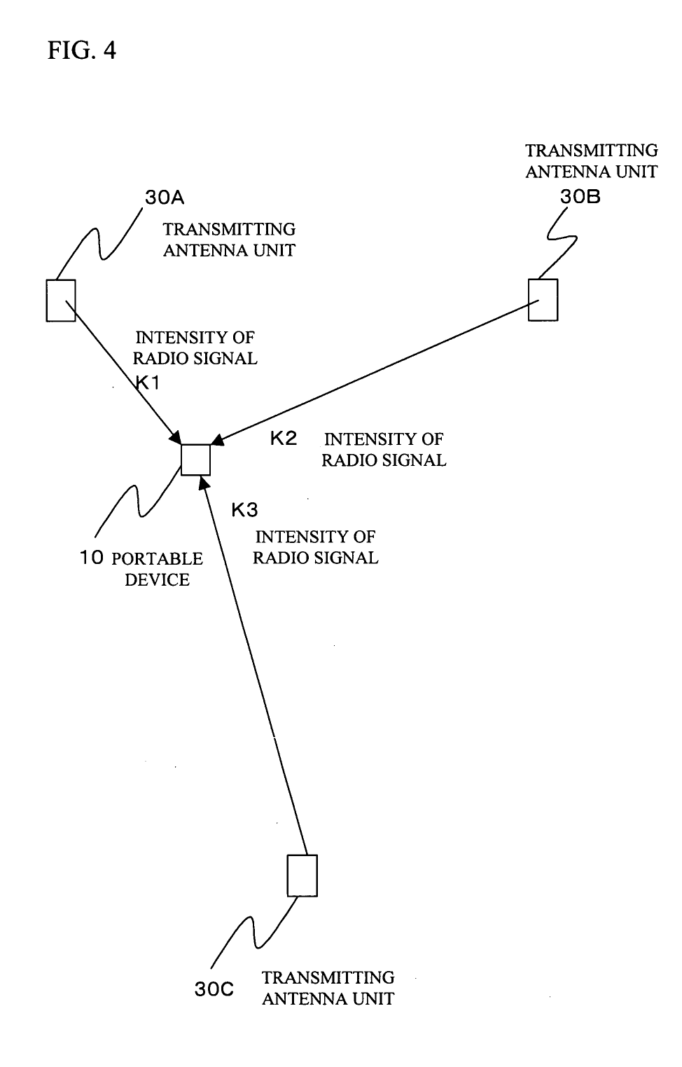

FIG. 1 is a functional block diagram showing a smart entry system in accordance with an exemplary embodiment of the present invention. FIG. 2 illustrates a configuration example of a portable device. FIG. 3 illustrates an example in which the smart entry system is applied to a vehicle. FIG. 4 illustrates a position detection principle of the portable device.

The smart entry system employed in an exemplary embodiment of the present invention is composed of: multiple portable devices 10 (10A through 10C); a smart entry ECU 20 serving as a processing portion (hereinafter, simply referred to as ECU 20); multiple transmitting antenna units 30A through 30C; a warning device 40; and the like.

The ECU 20 is composed of; hardware such as a processor, memory, and the like; and given software. The ECU 20 is installed in a vehicle, described later. In addition, the ECU 20 is connected to: a receiving antenna 21 that receives a high-frequency radio signal UHF; and a transmitting antenna that transmits a low-frequency radio signal LF. Furthermore, the ECU 20 is capable of transmitting signals to the multiple transmitting antenna units 30A through 30C to output various types of data thereto. Also, the ECU 20 is coupled to a vehicle ECU 100, and is capable of sending and receiving various types of data to and from the vehicle ECU 100. The vehicle ECU 100 controls various vehicle devices 110 included in the vehicle such as engine, brake, transmission, and the like. The vehicle ECU 100 may be respectively provided in each of the vehicle devices.

The warning device 40 is provided, for example, inside the vehicle to receive an instruction from the ECU 20 and give a warning to a user of the vehicle. Here, a buzzer or speaker equipped in a vehicle may be used as the warning device 40.

The multiple transmitting antenna units 30A through 30C are provided in the vehicle, described later, to output the low-frequency radio signal LF on the basis of the data supplied from the ECU 20, as shown in FIG. 1. There are provided at least three transmitting antenna units 30A through 30C in a vehicle to detect the position of each portable device 10, as will be described later.

Each portable device 10 is equipped with an antenna that can receive the low-frequency radio signal LF and transmit the high-frequency radio signal UHF, as shown in FIG. 1. The portable device 10 also includes: hardware such as the processor, memory, and the like; and given software. In addition, the portable device 10 is provided with: a door lock button BT1; a door unlock button BT2; and, for example, an auxiliary button BT3 used for locking or unlocking the vehicle trunk. Furthermore, the portable device 10 is also provided with a speaker SP serving as a warning portion to give a warning or notice to a user. The fundamental function of the portable device 10 is to receive the low-frequency radio signal LF from the transmitting antenna units 30A through 30C and then transmit an answering signal that includes an identification number ID of the portable device 10 by the high-frequency radio signal UHF. The answering signal is received by the receiving antenna 21 of the ECU 20.

The smart entry system described heretofore is applied to a vehicle 300, as shown in FIG. 3. The ECU 20 is, for example, arranged at the center portion inside the vehicle. The transmitting antenna units 30A and 30B are, for example, arranged near the doors at both sides, and the transmitting antenna unit 30C is arranged, for example, at the rear trunk. As shown in FIG. 3, when users U1 through U3 of respective portable devices 10A through 10C come close to the doors of the vehicle 300 and the portable devices 10A through 10C receive the radio signals LF from the transmitting antenna units 30A through 30C, the portable devices 10A through 10C transmit the answering signals that include the identification numbers IDs thereof to the receiving antenna 21 of the ECU 20. This allows the ECU 20 to recognize that the users U1 through U3 are close to the doors of the vehicle 300.

Meanwhile, a transmitting antenna 22 coupled to the ECU 20 transmits the low-frequency radio signal LF that can be received in a given area inside the vehicle 300. The users U1 through U3 get in the vehicle, and the portable devices 10A through 10C respectively receive the radio signals LF from the transmitting antenna 22 and transmits the answering signals that include IDs thereof to the receiving antenna 21 of the ECU 20. Thus, the ECU 20 is capable of detecting whether each portable device 10 is located inside or outside the vehicle 300. Also, the ECU 20 is capable of identifying each portable device 10, by obtaining the IDs of the portable devices 10A through 10C.

A description will now be given of an example of detecting the position of each portable device 10 in the above-described smart entry system. Referring now to FIG. 4, when the portable device 10 is in the range where any of the radio signals transmitted from the three transmitting antenna units 30A through 30C can be received, intensities K1, K2, and K3 of the radio signals transmitted from the three transmitting antenna units 30A through 30C are respectively detected and then transmitted to the receiving antenna 21 of the ECU 20. The ECU 20 calculates the position of the portable device 10 according to the principle of the triangular surveying with the intensities K1, K2, and K3.

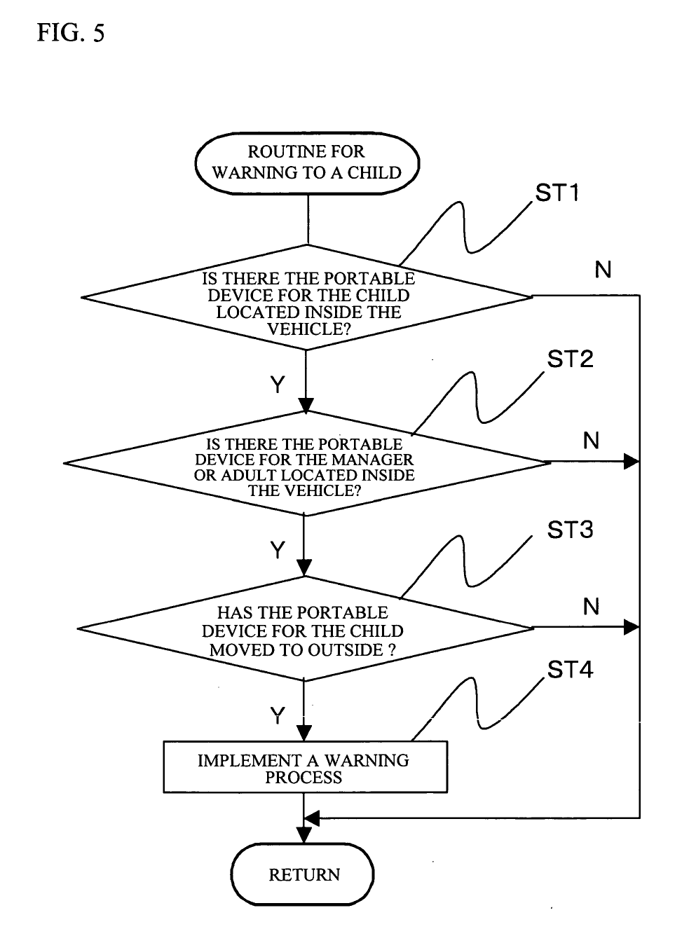

Next, a description will now be given, with reference to the flowchart shown in FIG. 5, of an example of a procedure performed by the ECU 20. As an exemplary embodiment, a description will be given of a case where a child in the vehicle is prevented from opening the door to get out of the vehicle freely. Here, it is supposed that the user U1 of FIG. 3 is an adult, who is a system manager (driver), for example, a father of the child, and the user U2 is an adult, for example, a mother of the child. It is also supposed that the ECU 20 has already recognized that the portable device A is carried by the system manager, the portable device 10B is carried by the adult, and the portable device 10C is carried by the child, from the preset information. It is supposed that the procedure of FIG. 5, if it is preset, is performed on a regular basis.

Referring now to FIG. 5, the ECU 20 determines where there is the portable device 10C carried by the child located inside the vehicle 300 (step ST1). If not, the procedure is ended. When the ECU 20 detects that there is the portable device 10C for the child located inside the vehicle 300, the ECU 20 determines whether there is the portable device 10A for the system manager or the portable device 10B for the adult located inside the vehicle 300 (step SDT2). This is to check whether the parent is also in the vehicle with the child. If there is not provided the portable device 10A or the portable device 10B located inside the vehicle 300, the procedure is ended.

When there is the portable device 10A or the portable device 10B located inside the vehicle 300, the ECU 20 checks whether the portable device 10C for the child has moved to outside from inside of the vehicle (step ST3). If the portable device 10C for the child has not moved to outside the vehicle, the procedure is ended. When the portable device 10C for the child has moved from inside the vehicle to outside, it can be considered that the child opens the door and gets out of the vehicle freely. Then, the ECU 20 performs a given warning process (step ST4). The warning process is, for example, to activate the warning device 40, to give a warning sound from the speaker SP of the portable device 10, or the like in order to notify the father of the system manager or the mother that the child has gotten out of the vehicle. This can prevent the child from opening the door and getting out of the vehicle freely before it happens. Even if the child opens the door and gets out of the vehicle freely, the parent is able to know in a moment that the child has gotten out of the vehicle. This makes it possible to enhance the safety of the child in the vehicle.

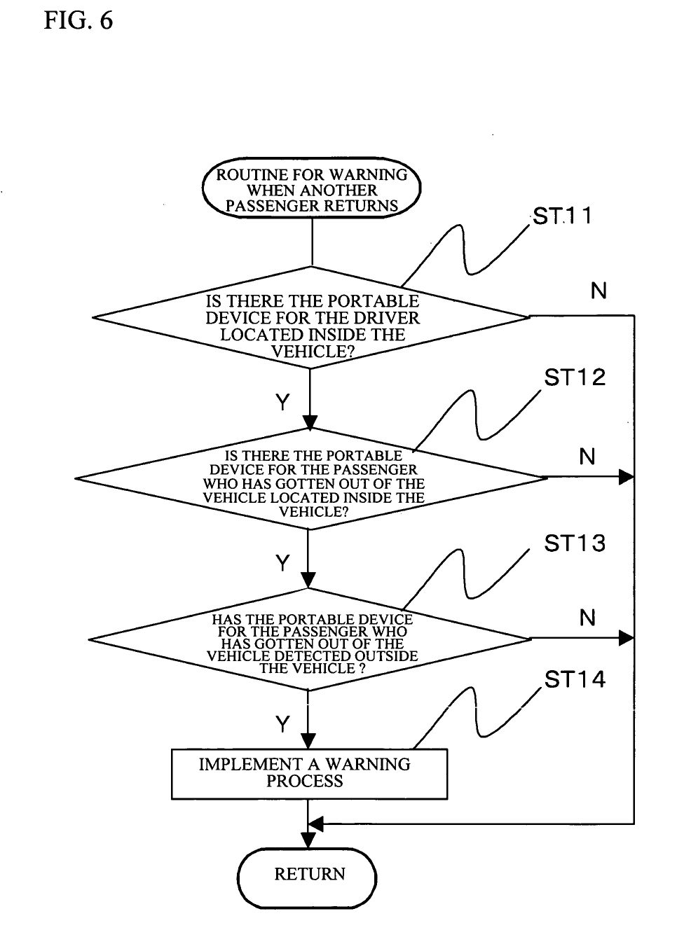

A description will now be given, with reference to the flowchart of FIG. 6, of alternative exemplary embodiment of the procedure performed by the ECU 20. In the present exemplary embodiment, a description will be given of a case where a passenger with the portable device 10B or 10C is outside the vehicle and the driver who is the system manager with the portable device 10A is waiting for the passenger in the vehicle, and then the ECU 20 notifies the driver that the passenger is coming back close to the vehicle. It is supposed that the ECU 20 recognizes that the portable device 10A is carried by the system manager with the preset information. The procedure of FIG. 6, if it is preset, is performed on a regular basis.

Referring now to FIG. 6, firstly, the ECU 20 determines whether there is the portable device 10A for the driver located inside the vehicle 300 (step ST11). If not, the procedure is ended. When the ECU 20 detects that there is portable device 10A for the driver located inside the vehicle 300, the ECU 20 determines whether there is another portable device 10B or 10C for the passenger who has gotten out of the vehicle (step ST12). The determination at step ST12 can be made by setting the information on the ECU 20 when the passenger gets out of the vehicle, or by automatically detecting that the passenger has gotten out of the vehicle. If there is no portable device 10B or 10C of the passenger who has gotten out of the vehicle, the procedure is ended.

Next, the ECU 20 determines whether the portable device 10B or 10C of the passenger who has gotten out of the vehicle is detected in the outside the vehicle (step ST13). If the portable device 10B or 10C of the passenger who has gotten out of the vehicle is not detected, the procedure is ended. If the portable device 10B or 10C of the passenger has gotten out of the vehicle is detected, the ECU 20 performs a given warning process (step ST14) to notify the drive that the passenger is coming back close to the vehicle. This makes it possible to wake up the sleeping driver with certainty, while the passenger is outside the vehicle.

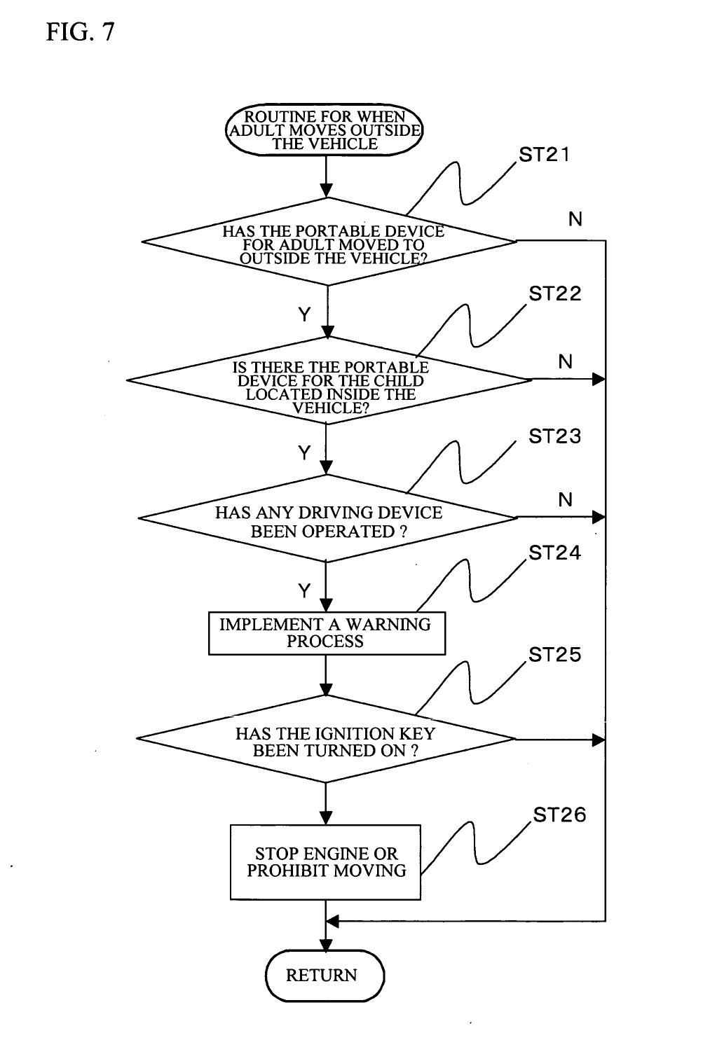

A description will now be given, with reference to the flowchart of FIG. 7, of alternative exemplary embodiment of the procedure performed by the ECU 20. The procedure of FIG. 7, if it is preset, is performed on a regular basis. In the present exemplary embodiment, a description will now be given of a case of preventing the child from freely touching or operating the driving devices of the vehicle, such as, for example, engine starting, shift knob operation, handle operation, horn operation, light operation, power window operation, and the like, while the father who is the system manager or the mother is outside the vehicle with the child left in the vehicle. In the present exemplary embodiment, the conditions are same as those described with reference to FIG. 5.

Referring now to FIG. 7, the ECU 20 firstly determines whether the portable device 10A or 10B for the adults has moved to outside the vehicle (step ST21). If not, the procedure is ended. When the portable device 10A or 10B for the adults has moved to outside the vehicle, the ECU 20 determines whether there is the portable device 10C located inside the vehicle (step ST22). If not, the procedure is ended.

When there is the portable device 10C for the child located inside the vehicle, the ECU 20 determines whether the operating device for driving, for example, the ignition key, shift knob, handle, horn, light, power window, or the like is operated (step ST23). If the operating device is operated, the ECU 20 outputs, for example, a warning sound or the like to make the child stop operating (step ST24).

The ECU 20 determines whether the ignition key is tuned on (step ST25). If the ignition key is tuned on, the ECU 20 outputs an engine stop instruction or an instruction to prohibit moving (step ST26) to the vehicle ECU 100. This can prevent the engine from starting when the child in mischief operates the ignition. In addition, the power window may be configured not to be activated.

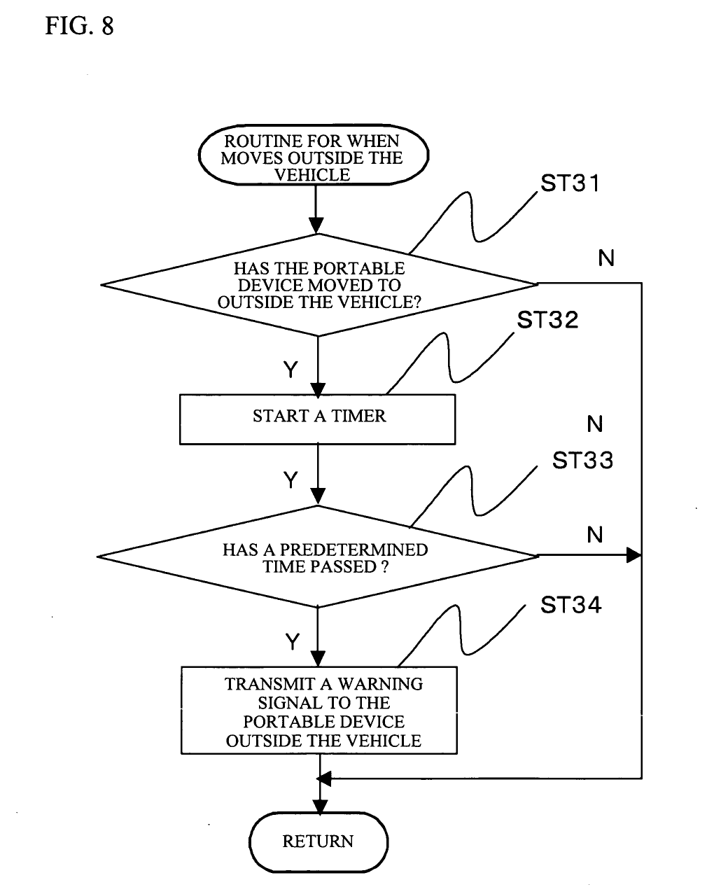

A description will now be given, with reference to the flowchart of FIG. 8, of alternative exemplary embodiment of the procedure performed by the ECU 20. The procedure of FIG. 8, if it is preset, is performed on a regular basis. In the present exemplary embodiment, a description will now be given of a case of preventing the vehicle 300 from being parked for a long time, because the driver or the passenger forgets the passage of time.

Referring now to FIG. 8, the ECU 20 determines whether any of the portable devices 10A through 10C has moved to outside the vehicle 300 (step ST31). If any of the portable devices 10A through 10C has moved to outside (step ST31), the ECU 20 starts a timer (step ST32). Then, the ECU 20 determines whether a predetermined period of time, for example, 30 minutes or one hour, has passed since the timer was started (step ST33). If the predetermined period of time has passed, the ECU 20 transmits, for example, a warning signal to the portable device 10 located outside the vehicle.

The warning signal allows the driver or passenger who is outside the vehicle to know that a given period of time has passed. It is also considered that the radio signal transmitted from the ECU 20 cannot be received by the portable device 10 of the owner who is outside the vehicle. In the afore-described case, it may be configured such that when the ECU 20 starts the timer thereof, the ECU 20 may also activate a built-in timer of the portable device 10 of the owner who is going outside the vehicle, so that the portable device 10 can learn whether a given period of time has passed.

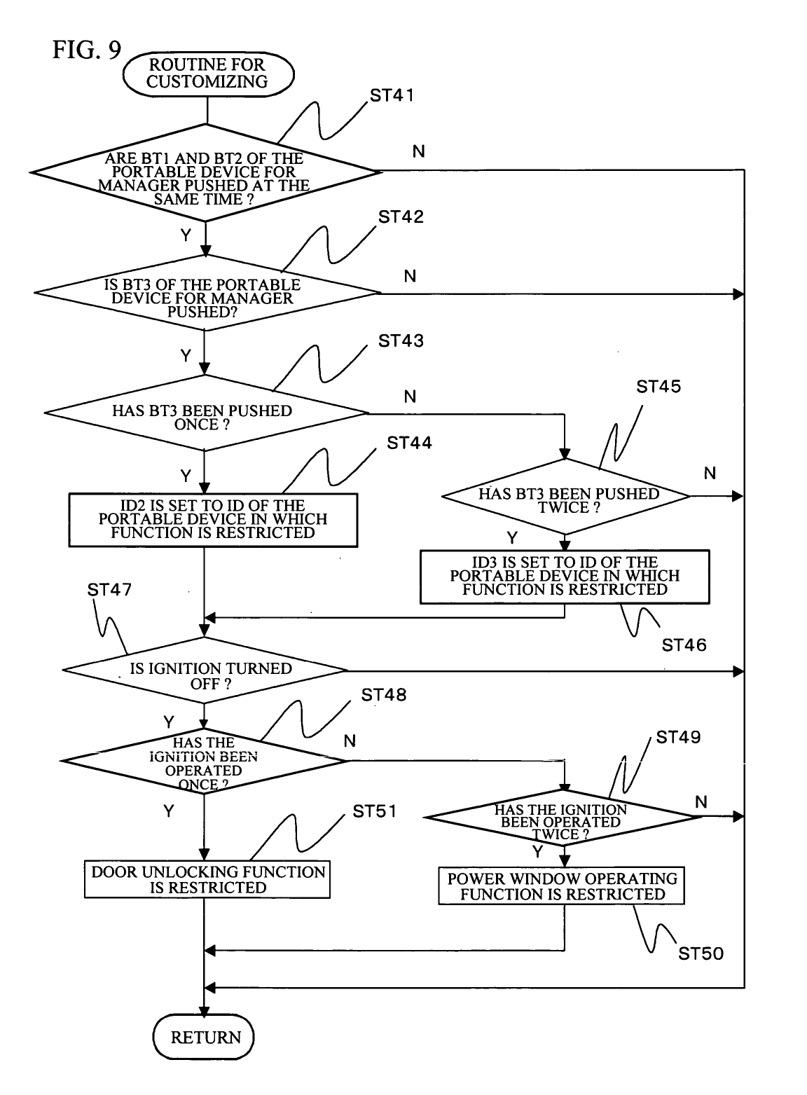

A description will now be given, with reference to the flowchart of FIG. 9, of alternative exemplary embodiment of the procedure performed by the ECU 20. The procedure of FIG. 9, if it is preset, is performed on a regular basis. In the present exemplary embodiment, a description will be given of a case where the functions of the portable devices 10B and 10C are customized by use of the portable device 10A of the system manager. Here, ID2 and ID3 respectively represent the IDs of the portable devices 10B and 10C. In the present exemplary embodiment, the functions of the portable devices are customized for the purpose of restricting the engine starting function or the power window operating function, if the portable devices are equipped with the afore-described functions, because it is dangerous for the child to operate the afore-described functions. However, the present exemplary embodiment is not limited thereto.

Referring now to FIG. 9, the ECU 20 firstly determines whether two buttons BT1 and BT2 of the portable device 10A of the system manager are pushed at the same time (step ST41). If the two buttons BT1 and BT2 are pushed at the same time, the ECU 20 determines whether a button BT3 of the portable device 10A is pushed (step ST42). That is to say, when the two buttons BT1 and BT2 are pushed at the same time and the button BT3 is also pushed, the ECU 20 determines that the portable device 10A is in a customize mode.

Next, the ECU 20 determines whether the button BT3 is pushed once (step ST43). If the button BT3 is pushed once, ID2 is set to the ID of the portable device 10B to be customized, namely, the functions of thereof are to be restricted. If the button BT3 is pushed twice, ID3 is set to the ID of the portable device 10C to be customized, namely, the functions of thereof are to be restricted.

Then, the ECU 20 determines whether the ignition of the vehicle is turned off (step ST47). If the ignition is operated, the ECU 20 determines whether the ignition is operated once or twice (step ST48, step ST49). If the ignition is operated once, the door unlocking function of the portable device 10B or 10C selected is restricted (step ST51). If the ignition is operated twice, the power window operating function is restricted (step ST50).

As stated, with not only the buttons BT1 through BT3 of the portable device 10A but also the operating device such as the ignition equipped in the vehicle, a more complicated customized operation is enabled.

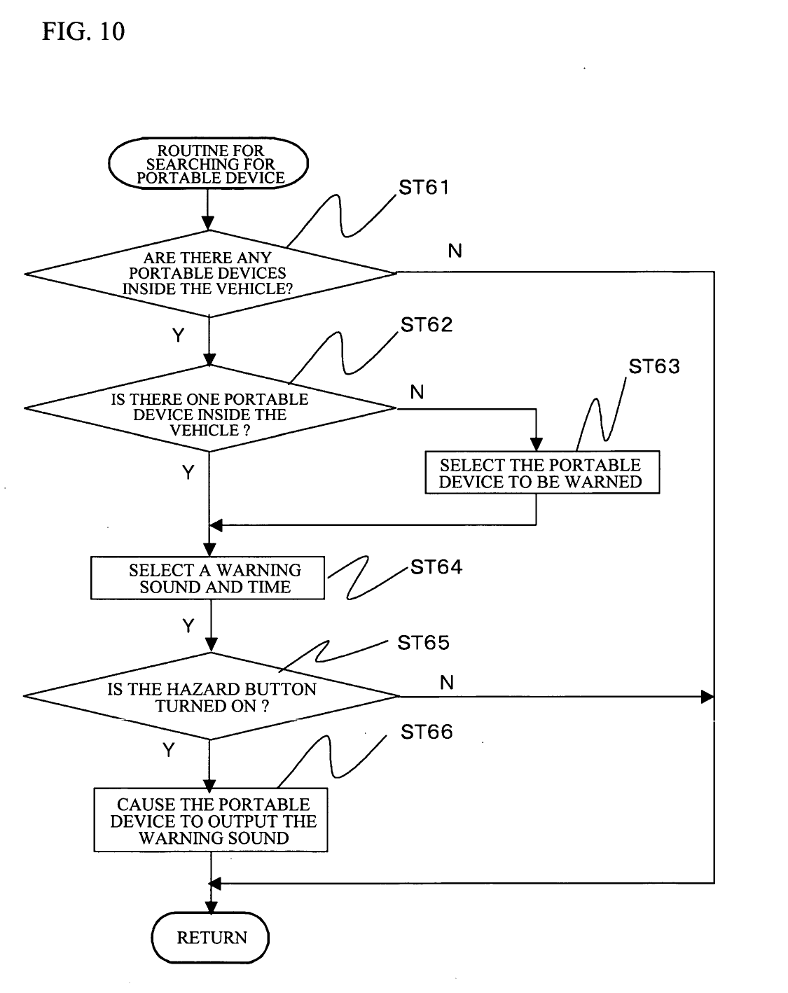

A description will now be given, with reference to the flowchart of FIG. 10, of alternative exemplary embodiment of the procedure performed by the ECU 20. The procedure of FIG. 10, if it is preset, is performed on a regular basis. In the present exemplary embodiment, a description will be given of an example of the procedure of helping search for the portable device 10 when the portable device 10 is dropped or lost inside the vehicle and cannot be found. Firstly, the ECU 20 determines whether there is the portable device 10 located inside the vehicle (step ST61). If there is the portable device 10 located inside the vehicle, the ECU 20 determines whether or not there is one portable device 10 located inside the vehicle (step ST62). This is because the portable device 10 to be searched for is specified.

If there are several portable devices 10 located inside the vehicle, for example, there are two portable devices, one of the portable devices 10 is to be searched for and the other portable device 10 is carried by a user. Then, the ECU 20 requests the portable device 10 carried by the user to select the ID of the portable device 10 to be searched for (step ST63).

Next, the ECU 20 selects a warning sound or a warning time to be output from the portable device 10 to be searched for (step ST64). Then, the ECU 20 determines whether a hazard button equipped in the vehicle is pushed (step ST65). When the hazard button is pushed, the ECU 20 causes the portable device 10 searched for to output the warning sound (step ST66). This makes it easy to find out the portable device 10 that is missing.

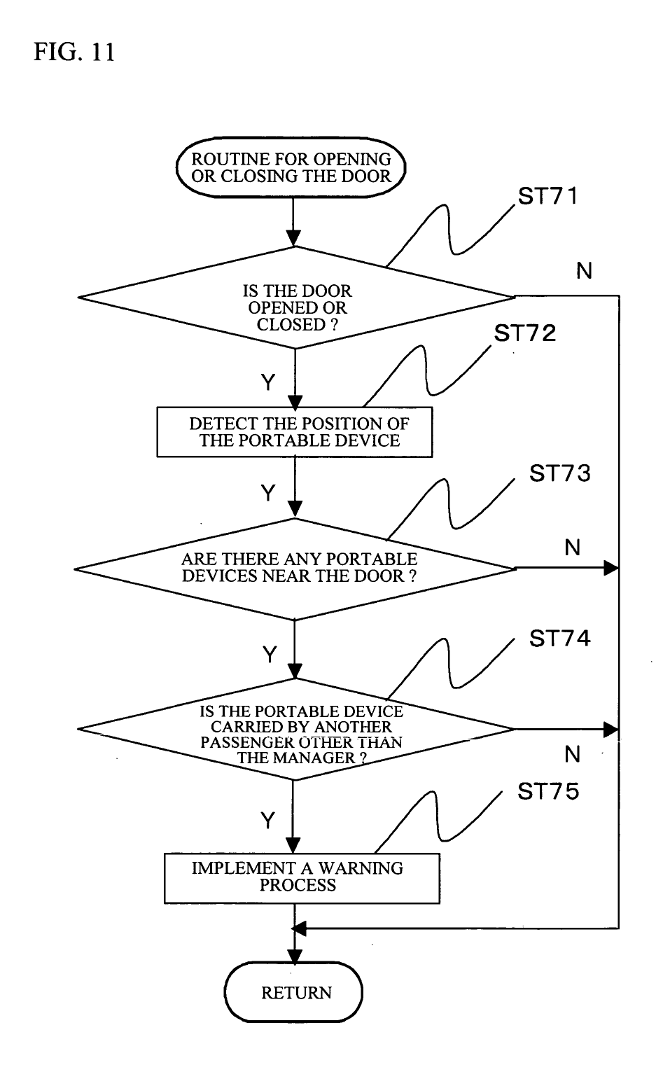

A description will now be given, with reference to the flowchart of FIG. 11, of alternative exemplary embodiment of the procedure performed by the ECU 20. The procedure of FIG. 11, if it is preset, is performed on a regular basis. In the present exemplary embodiment, a description will be given of an example of the procedure of preventing a finger of another passenger such as a child, placed near the door, from being stuck in the door when the system manager, namely, the driver is opening or closing the door of the driver.

Firstly, the ECU 20 determines whether the vehicle door is opened or closed (step ST71). For instance, opening or closing the door of the vehicle can be detected, when the portable device 10A of the system manager (driver) moves from inside the vehicle to outside, or when the portable device 10A of the system manager (driver) moves from outside the vehicle to inside.

When the vehicle door is opened or closed, the ECU 20 detects the position of each portable device 10 with the use of, for example, the position detecting function described with reference to FIG. 4 (step ST72). The ECU 20 determines whether there is a portable device 10 near the door to be opened or closed according to the detected position of each portable device 10 (step ST73). If there is a portable device 10 near the door to be opened or closed, there is the possibility that someone is located near the door. Then, the ECU 20 determines whether the portable device 10 located near the door is carried by another passenger other than the system manager (driver) (step ST74). If the portable device 10 is carried by another passenger other than the system manager, the ECU 20 performs the warning process (step ST75). This makes it possible to prevent the accident that a finger is stuck in the door from occurring.

In the above-described exemplary embodiment, a description has been given of a case where the function of the portable device 10 is customized by use of the buttons of the portable device together with the ignition key. However, the present invention is not limited thereto. The function of the portable device 10 may be customized by use of the buttons of the portable device together with another operating device equipped in the vehicle. The function of the portable device 10 may also be customized by use of only an operating device.

In the above-described exemplary embodiment, a description has been given of a case where a speaker is used as a warning portion of the portable device. The present invention, however, is not limited thereto. For example, a vibrator or another warning portion (notifying portion) may be employed, and two or more warning portions may be used together.

In the above-described exemplary embodiment, the hazard button is used to search for the portable device 10 in the vehicle. The present invention, however, is not limited thereto. Another button, switch, or the like equipped in the vehicle may be used.

In the above-described exemplary embodiment, a description has been given of a case where the portable device 10 is equipped with the three buttons BT1 through BT3. The present invention, however, is not limited thereto. Another type of device, for example, a mobile telephone may be employed for the portable device.

In the above-described exemplary embodiment, a description has not given, in particular, to a method how each user carries the portable device. The portable device may be attached to the cloth or may be worn on a wrist like a watch.

Finally, various aspects of the present invention are summarized in the following.

According to an aspect of the present invention, there is provided a smart entry system for vehicle including a processing portion that performs a given procedure according to a positional relationship of multiple portable devices with respect to a vehicle, the multiple portable devices being respectively carried by users and being detectable at least whether the multiple portable devices are located inside or outside the vehicle.

In the above-described smart entry system, when the processing portion detects that at least any of the multiple portable devices comes close to or moving away from the vehicle, the processing portion may perform a warning process to a user inside the vehicle. When the passenger with a portable device comes back close to the vehicle from the outside the vehicle, the warning process is performed to automatically notify the passenger in the vehicle. When the passenger with a portable device moves outside from inside of the vehicle, for example, when a child freely opens a door and goes out, the warning process is performed to automatically inform the passenger in the vehicle.

In the above-described smart entry system, when the processing portion detects that any of the multiple portable devices has moved from inside to outside the vehicle in a state where a portable device carried by a system manager is located inside the vehicle, the processing portion may perform a warning process to a user including at least the system manager. It is therefore possible to notify the user, for example a child, other than a system manager, for example a driver of the vehicle has moved outside the vehicle to the system manager.

In the above-described smart entry system, a driving device may be operated in a state where a portable device carried by a system manager has moved to outside the vehicle and another portable device is located inside the vehicle, the processing portion performs a warning process to a user including at least the system manager. When a user, for example, a child is operating the driving device such as the steering wheel, the ignition key, or the like while the system manager, for example, a vehicle driver is in the outside the vehicle, a warning is automatically given to the system manger or another user. This makes it possible to prevent the dangerous conduct of the child in mischief such as operating the vehicle.

In the above-described smart entry system, when a vehicle engine is started in a state where the processing portion is performing the warning process, the processing portion may stop the vehicle engine or stops moving the vehicle. In addition to a warning, the engine is stopped or the moving of the vehicle is prohibited, ensuring the safety with certainty.

In the above-described smart entry system, when the processing portion detects another portable device in the outside of the vehicle in a state where the portable device carried by a system manager is located inside the vehicle, the processing portion may perform a warning process to a user including at least the system manager. For example, the driver who is a system manager sleeps may be notified that the passenger comes back close to the vehicle automatically.

In the above-described smart entry system, each of the multiple portable devices may be equipped with a warning portion that gives a warning to the user including a system manager; and the processing portion may perform the warning process by activating the warning portion. It is possible to give a warning to the user directly and with certainty. The warning portion may employ sound, light, vibration, or the like.

In the above-described smart entry system, a warning function of the warning portion may be customizably formed. The warning portion that uses the sound, light, vibration or the like equipped in the portable device may be customized according to the content of the warning or the type of the user, allowing the user to understand the content of the warning sensuously.

In the above-described smart entry system, the warning portion can be activated by operating operation buttons equipped in the vehicle. If the portable device is dropped in the vehicle and cannot understand where the portable device is, the warning sound or the like can be generated from the portable device by operating the operation button provided at the vehicle, for example, a hazard button, it is possible to find the portable device in a relatively simple manner.

In the above-described smart entry system, a function of any of the multiple portable devices can be customized by operating at least a portable device to be carried by a system manager. The function of the portable device to be used by the child is restricted, for example, to prevent the child from doing a dangerous operation.

In the above-described smart entry system, the processing portion may count a time since any of the multiple portable devices has moved from outside to inside the vehicle, and may perform a warning process when the time counted passes a preset time. It is possible to notify the user of the time since the user left the vehicle.

The above-described smart entry system may further include a position detecting portion. The processing portion may determine whether there is another portable device near a vehicle door other than the portable device carried by a system manager, and may perform a warning process to a user when there is the another portable device near the vehicle door.

According to another aspect of the present invention, there is provided a warning method in a smart entry system for vehicle including performing a given procedure according to a positional relationship of multiple portable devices with respect to a vehicle, the multiple portable devices being respectively carried by users and being detectable at least whether the multiple portable devices are located inside or outside the vehicle.

Although a few specific exemplary embodiments employed in the present invention have been shown and described, it would be appreciated by those skilled in the art that changes may be made in these exemplary embodiments without departing from the principles and spirit of the invention, the scope of which is defined in the claims and their equivalents.

The present invention is based on Japanese Patent Application No. 2005-339798 filed on Nov. 25, 2005, the entire disclosure of which is hereby incorporated by reference.

What is claimed is:

1. A smart entry system for vehicle comprising a processing portion that performs a given procedure according to a positional relationship of multiple portable devices with respect to a vehicle, the multiple portable devices being respectively carried by users and being detectable at least whether the multiple portable devices are located inside or outside the vehicle.

2. The smart entry system as claimed in claim 1, wherein when the processing portion detects that at least any of the multiple portable devices comes close to or moving away from the vehicle, the processing portion performs a warning process to a user inside the vehicle.

3. The smart entry system as claimed in claim 1, wherein when the processing portion detects that any of the multiple portable devices has moved from inside to outside the vehicle in a state where a portable device carried by a system manager is located inside the vehicle, the processing portion performs a warning process to a user including at least the system manager.

4. The smart entry system as claimed in claim 1, wherein when a driving device is operated in a state where a portable device carried by a system manager has moved to outside the vehicle and another portable device is located inside the vehicle, the processing portion performs a warning process to a user including at least the system manager.

5. The smart entry system as claimed in claim 4, wherein when a vehicle engine is started in a state where the processing portion is performing the warning process, the processing portion stops the vehicle engine or stops moving the vehicle.

6. The smart entry system as claimed in claim 1, wherein when the processing portion detects another portable device in the outside of the vehicle in a state where the portable device carried by a system manager is located inside the vehicle, the processing portion performs a warning process to a user including at least the system manager.

7. The smart entry system as claimed in claim 2, wherein:
each of the multiple portable devices is equipped with a warning portion that gives a warning to the user including a system manager; and
the processing portion performs the warning process by activating the warning portion.

8. The smart entry system as claimed in claim 7, wherein a warning function of the warning portion is customizably formed.

9. The smart entry system as claimed in claim 7, wherein the warning portion can be activated by operating operation buttons equipped in the vehicle.

10. The smart entry system as claimed in claim 1, wherein a function of any of the multiple portable devices can be customized by operating at least a portable device to be carried by a system manager.

11. The smart entry system as claimed in claim 1, wherein the processing portion counts a time since any of the multiple portable devices has moved from inside to outside the vehicle, and performs a warning process when the time counted passes a preset time.

12. The smart entry system as claimed in claim 1, further comprising a position detecting portion,
wherein the processing portion determines whether there is another portable device near a vehicle door other than the portable device carried by a system manager, and performs a warning process to a user when there is the another portable device near the vehicle door.

13. A warning method in a smart entry system for vehicle comprising performing a given procedure according to a positional relationship of multiple portable devices with respect to a vehicle, the multiple portable devices being respectively carried by users and being detectable at least whether the multiple portable devices are located inside or outside the vehicle.
